(19) United States
(12) Patent Application Publication
(10) Pub. No.: US 2014/0302733 A1
(43) Pub. Date: Oct. 9, 2014

(54) Chemically Curable Bonding Film Adhesive with Uniform Thickness

(71) Applicant: The Boeing Company, (US)

(72) Inventor: Jeffrey Edward Polus, Hillsboro, IL (US)

(73) Assignee: THE BOEING COMPANY, Chicago, IL (US)

(21) Appl. No.: 13/859,205

(22) Filed: Apr. 9, 2013

(51) Int. Cl. C09J 7/00; B32B 5/02; B32B 7/12; B32B 37/12

(52) U.S. Cl. CPC C09J 7/00; B32B 37/1284; B32B 5/028; B32B 7/12
USPC 442/1; 156/60; 428/343; 428/323; 525/523

(57) ABSTRACT

Composite parts may be bonded together at room temperature using an adhesive resin film that is chemically activated to cure when placed in contact with a scrim containing a catalyst.

### CROSS REFERENCE TO RELATED APPLICATIONS

This application is related to co-pending U.S. patent application Ser. No. ______, (Attorney Docket No. 12-1417-US-NP2 filed concurrently herewith on ______, which is incorporated by reference herein in its entirety.

### BACKGROUND INFORMATION

1. Field

The present disclosure generally relates to adhesives, and deals more particularly with a film adhesive for bonding composite parts, particularly at room temperature.

2. Background

Composite parts may be bonded together using a paste adhesive that cures at room temperature. The paste adhesive comprises a two-part mix of resin and a catalyst that activates the resin to cure at room temperature.

Currently used paste adhesives that cure at room temperature present several challenges. For example, it is necessary to mix the resin and the catalyst in the correct portions in order to achieve a bond having a desired mechanical performance and electrical properties, and which cures in a desired time period. These adhesives may also be difficult and time-consuming to apply. A serrated trowel or squeegee is normally used to apply and spread the adhesive over a bond surface, however achieving an even distribution of the paste with constant thickness over the entire area of the bond surface is difficult to achieve.

Accordingly, there is a need for an adhesive for bonding composite parts at room temperature that eliminate the need for mixing, can be easily applied, and results in a bondline of uniform thickness and distribution. There is also a need for a simple and effective method of making the adhesive.

### SUMMARY

Composite parts may be bonded together at room temperature. An adhesive bond is formed using an adhesive resin film that is chemically activated to cure when placed In contact with a scrim containing a catalyst. The adhesive resin film may be produced by production processes such as extrusion in order to form a layer of adhesive resin at the bondline that is substantially constant in thickness and distribution throughout the bond area. Consistency in thickness and distribution of the adhesive improve the mechanical properties of the bond. The use of adhesive film, rather than paste, eliminates the need for mixing components of the adhesive, and may provide longer working times to allow parts to be placed into position and adjusted before the bond sets.

According to one embodiment, an adhesive bonding film is provided comprising at least a first layer of activatable resin, and a coating adapted to be placed in contact with the layer of resin for activating curing of the layer of resin. The adhesive bonding film may further comprise a scrim wherein the coating is on the scrim. The adhesive bonding film may also comprise a second layer of activatable resin, wherein the scrim is sandwiched between the first and second layers of curable resin. The scrim includes a coating of a material acting as a catalyst to activate curing of the layer of resin. The material acting as a catalyst is selected from the group consisting of amines or micro-capsulated activators. The coating may comprise a silane. The coating of material acting as a catalyst is encapsulated by a frangible layer preventing exposure of the material acting as the catalyst to the activatable resin. The scrim may include at least one of a peroxide base, titanium base, or platinum base. The scrim may be an open weave of glass fibers, and the activatable resin may include a hydrophobic fumed silica for thickening the activatable resin. The activatable resin is activated by the scrim to cure at substantially room temperatures.

According to a further embodiment, an adhesive bonding film is provided comprising at least one layer of chemically curable resin, and an encapsulated curing agent that is released from encapsulation to activate curing of the chemically curable resin in response to application thereto of a force. The bonding film may further comprise a scrim, wherein the curing agent is a coating on the scrim. The encapsulated curing agent may include substantially continuous fibers each including a curing agent core and a frangible outer coating. The outer coating normally forms a barrier between the curing agent core and the chemically curable resin, but is breakable to expose the curing agent core to the chemically curable resin. The continuous fibers may be arranged in layers distributed through a thickness of a layer of the chemically curable resin. In another variation, the encapsulated curing agent includes a plurality of generally randomly oriented fibers. Each of the fibers includes a curing agent core and a frangible outer coating surrounding the curing agent core.

According to still another, a method is provided of making an adhesive bonding film. The method comprises forming at least one layer of an activatable adhesive, coating a scrim with a catalyst, and chemically activating the adhesive by placing the coated scrim in contact with the layer of activatable adhesive. The activation of the adhesive may be performed at substantially room temperature. Coating the scrim includes applying an aminosilane to the scrim. The method may further comprise thickening the activatable adhesive with a hydrophobic fumed silica.

According to another embodiment, a method is provided of forming an adhesive bond at room-temperature, comprising forming a layer of resin, forming a separate scrim cloth, and using the scrim cloth to chemically activate curing of the resin layer. Using the scrim cloth to chemically activate curing is performed using a catalyst selected from the group consisting of a peroxide base, a titanium (TI) base, and a platinum base.

The features, functions, and advantages can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and advantages thereof, will best be understood by reference to the following detailed description of an illustrative embodiment of the present disclosure when read in conjunction with the accompanying drawings, wherein:

FIG. 1 is an illustration of a sectional view of an adhesive bond joining two composite laminates, according to one embodiment of the disclosed adhesive film.

FIG. 2 is an illustration of an exploded, perspective view showing the construction of the adhesive film shown in FIG. 1.

FIG. 3 is an illustration of a sectional view taken along the line 3-3 in FIG. 1.

FIG. 4 is an illustration of a sectional view similar to FIG. 3, but showing an alternate embodiment of the scrim.

FIG. 5 is an illustration of a sectional view similar to FIG. 4, but showing de-capsulation of a curing agent on the scrim which exposes the resin to a curing agent.

FIG. 6 is an illustration of a cross-sectional view of another embodiment of an adhesive film.

FIG. 7 is a sectional view taken along the line 7-7 in FIG. 6.

FIG. 8 is an illustration of a cross-sectional view of a further embodiment of the adhesive film.

FIG. 9 is a longitudinal view of one of the capsulated activators shown in FIGS. 6-8, an outer encapsulating coating having been broken to release the activator.

FIG. 10 is an illustration of a cross-sectional view of another embodiment of the adhesive bond for joining two composite laminates, the laminates shown just before being assembled together.

FIG. 11 is an illustration similar to FIG. 10 but showing the laminates having been assembled together and the scrim having been forced into a layer of bonding adhesive.

FIG. 12 is an illustration of an exploded, cross-sectional view showing a further embodiment of the adhesive bond for joining two composite laminates, the laminates shown just before being assembled together.

FIG. 13 is an illustration similar to FIG. 12 but showing the laminates having been assembled together along with a scrim.

FIG. 14 is an illustration of an exploded, cross-sectional view of still another embodiment of an adhesive bond for joining two composite laminates.

FIG. 15 is an illustration of an enlarged, sectional view of a portion of the bond formed after assembling the laminates shown in FIG. 14.

FIG. 16 is an illustration of a combined block and sectional view of a bonded joint employing another embodiment of the adhesive film activated by induction heating.

FIG. 17 is an illustration of the area designated as “FIG. 17” in FIG. 16.

FIG. 18 is an illustration of a longitudinal sectional view of one of the encapsulated nano-particles shown in FIG. 17.

FIG. 19 is an illustration of a sectional view taken along the line 19-19 in FIG. 18.

FIG. 20 is an illustration of a flow diagram of one embodiment of a method of making an adhesive bonding film.

FIG. 21 is an illustration of a flow diagram of another embodiment of a method of making an adhesive bonding film.

FIG. 22 is an illustration of a flow diagram of a further method of forming a bonded joint using an adhesive bonding film.

FIG. 23 is an illustration of a flow diagram of an adhesive bonding of method using an adhesive film that is activated by induction heating.

FIG. 24 is an illustration of a flow diagram of aircraft production and service methodology.

FIG. 25 is illustration of a block diagram of an aircraft.

### DETAILED DESCRIPTION

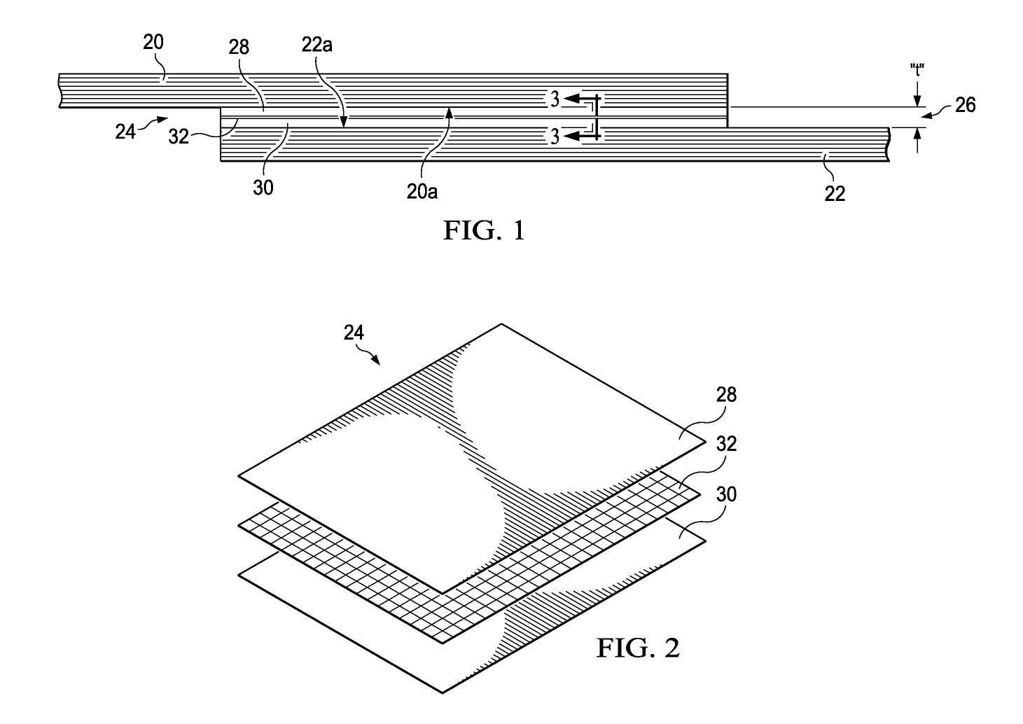

Referring first to FIGS. 1 and 2, composite parts 20, 22 may be bonded together along bond surfaces 20a, 22a using an adhesive film 24. The adhesive film 24 may be cured substantially at room temperature to form a bondline 26 of a desired, substantially constant thickness “t”. The adhesive film 24 comprises a scrim 32 sandwiched between first and second raw resin layers 28, 30. As will be discussed below in more detail, the scrim 32 functions to both reinforce the bondline 26, as well as to activate curing of the adhesive film 24 at substantially room temperature.

The scrim 32 may comprise a scrim cloth formed of, for example and without limitation, glass fibers, and may have an open weave, as best seen in FIG. 2. The scrim 32 may include at least one of a peroxide base, a titanium base, or a platinum base.

The resin forming the raw resin layers 28, 30 may comprise an activatable thermoset resin, such as, without limitation, epoxy resin. The resin may be thickened by mixing it with a hydrophobic fumed silica. In some embodiments, the adhesive film 24 may comprise only a single layer 28 or 30 of raw resin. The thicknesses of the resin layers 28, 30 as well as that of the scrim 32 will depend on the application. In one typical implementation, for example and without limitation, each of the resin layers 28, 30 may be about 3 to 4 mm in thickness, and the scrim 32 may comprise glass fibers having a thickness of approximately 1 mm.

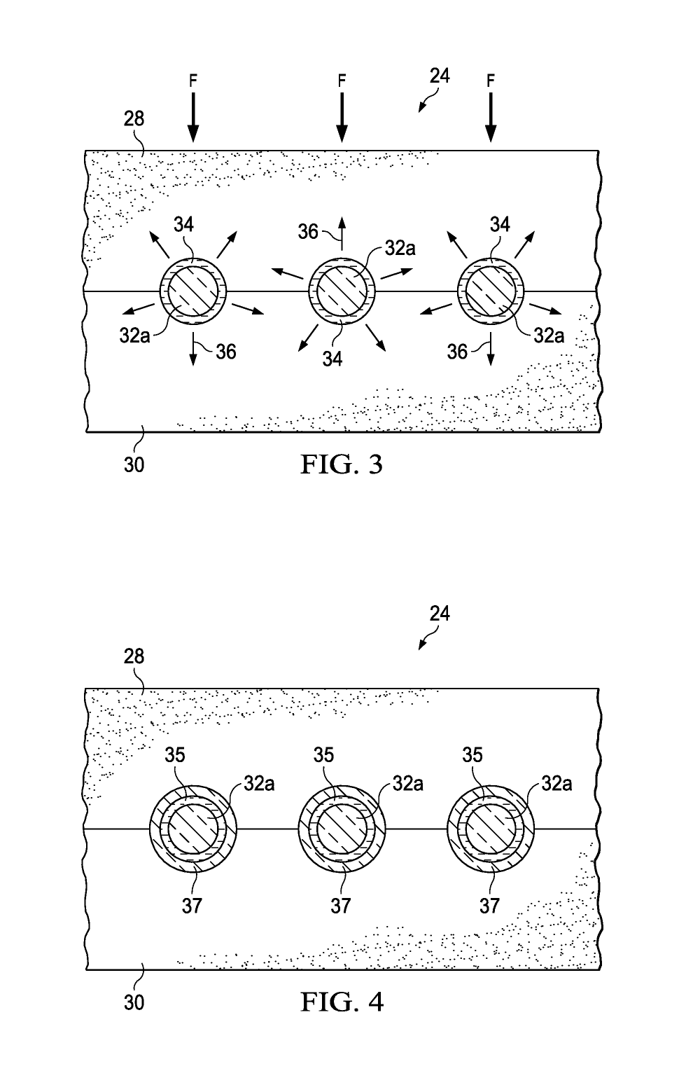

Referring now also to FIG. 3, the glass fibers 32a forming the scrim 32 are shown as having generally circular cross-sectional shapes, however other cross-sectional shapes may be possible or desirable, such as, without limitation, a generally flat cross-sectional shape (not shown). In the illustrated example, the raw resin layers 28, 30 are of substantially equal thickness, however in other embodiments their thicknesses may not be equal.

Each of the raw resin layers 28 may be produced by extruding resin to a desired, constant thickness, or by rolling a constant thickness of resin over a tool or other substrate in order to achieve a uniform distribution of resin; other fabrication techniques may be possible. The scrim 32 has an outer activator coating of a material that functions as an activator or catalyst to produce curing of the resin layers 28, 30. The activator coating 34 may be selected from the group consisting of amines or micro-encapsulated activators. For example, and without limitation, the activator coating 34 may be formed by treating the scrim 32 with a silane, such as an aminosilane, causing the glass fibers 32a to be coated with aminosilane, sometimes referred to as an amine curing agent.

In use, in preparation for bonding the two parts 20, 22 together, the adhesive film 24 is assembled by placing the scrim 32 between the two layers 28, 30 of raw resin, and then placing the adhesive film 24 between the bonding surfaces 20a, 22a. The two parts 20, 22 are forced together using any suitable technique, such as mechanical clamping or vacuum bagging. The applied pressure forces the scrim 32 against and partially into the raw resin layers 28, 30. Physical contact between the activator coating 34 and the curable resin in layers 28, 30 results in chemical activation and curing 36 (FIG. 3) of the resin.

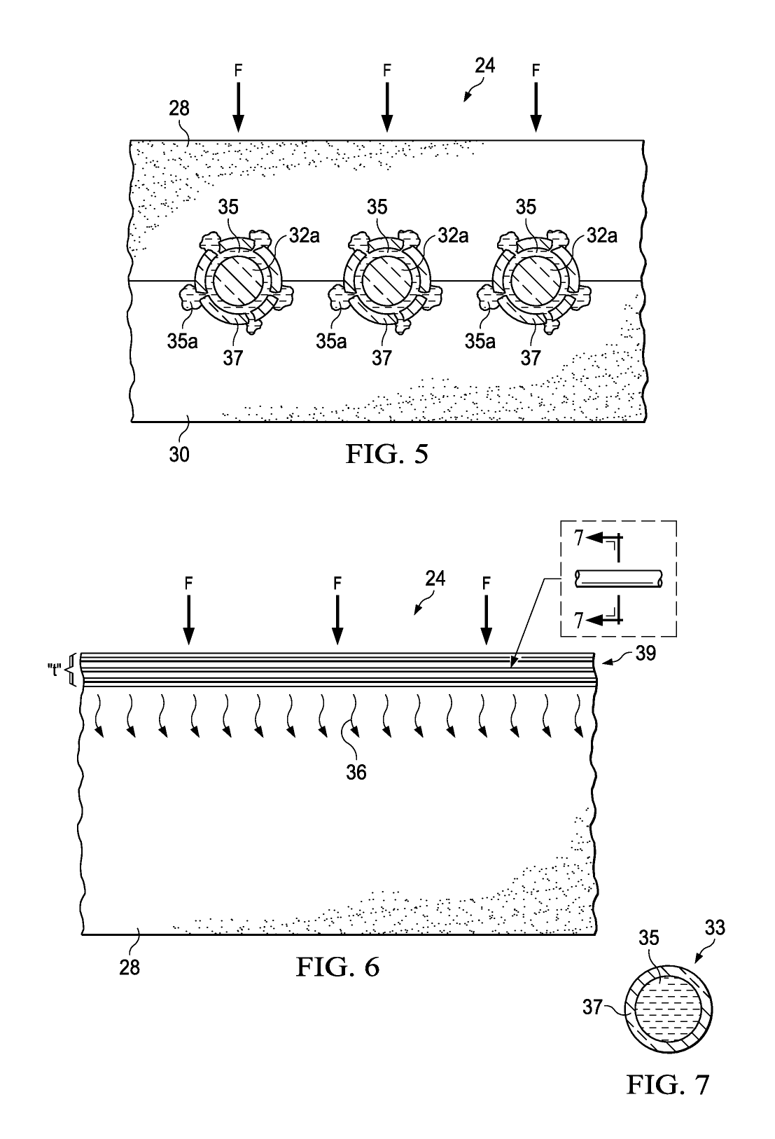

FIGS. 4 and 5 illustrate an alternate embodiment in which the fibers 32a of the scrim 32 are coated with a suitable curing agent 35 which is in turn encapsulated by a frangible layer 37 of material, such as glass. In this example, the resin layers 28, 30 and the scrim 32 may be preassembled in advance of a bonding operation, since the curing agent 35 is separated from the resin by the frangible layer 37, thereby preventing activation of resin. After being placed between two parts 20, 22 (FIG. 1) to be bonded, a force “F” may be applied to one or both of the parts 20, 22 using the vacuum bag pressure, a roller or other suitable techniques. The force “F” applied to the parts 20, 22 results in a compression of the adhesive film 24, causing deformation of the frangible layer 37 to the point that it breaks or separates. Breaking/separating of the frangible layer 37 effectively releases the curing agent from encapsulation, exposing it to the surrounding resin which chemically activates curing of the resin layers 28, 30.

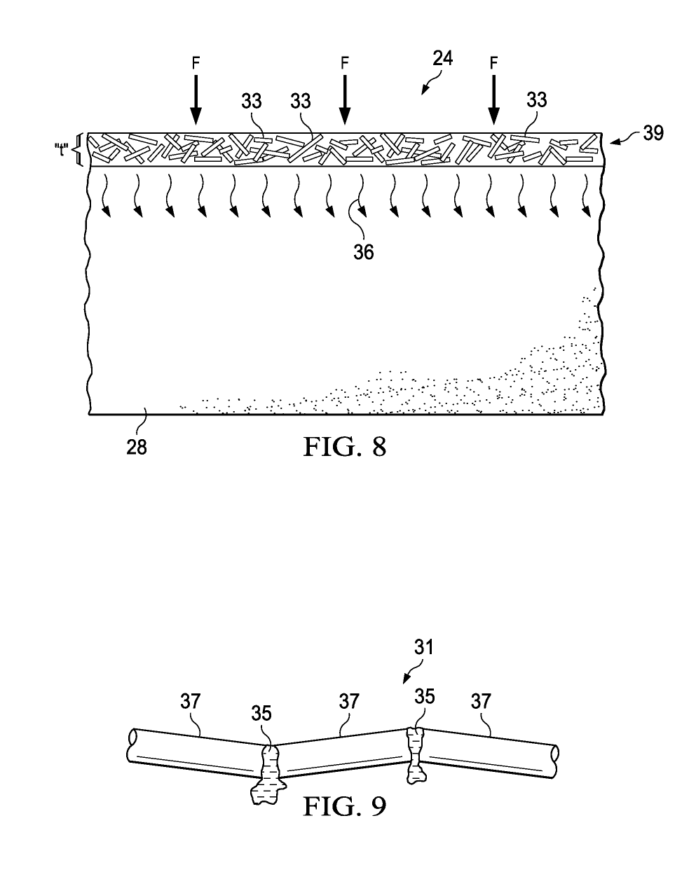

Attention is now directed to FIGS. 6-9 which illustrate a further embodiment of an adhesive film 24 in which one or more layers of resin 28 are cured through chemical activation by curing fibers 33 that are embedded within an outer layer 39 of the resin 28. In one embodiment, shown in FIG. 6, the embedded curing fibers 33 may be substantially continuous, embedded immediately below a surface of the adhesive film 24. The curing fibers 33 may be arranged in layers within a thickness “t” of the adhesive film 24. In another embodiment, shown in FIG. 8, the curing fibers 33 may be discontinuous and randomly oriented. The curing fibers 33 include a core 35 encapsulated by a frangible coating 37. The core comprises a suitable curing agent, similar to that previously described in connection with FIGS. 4 and 5, which functions to chemically activate the resin 28, substantially at room temperature. The frangible coating 37 forms a barrier between the curing agent core 35 and the surrounding resin 28 that prevents exposure of the resin 28 to the curing agent core 35 until activation of the adhesive film 24 is desired. When a force F is applied to the adhesive film 24, either immediately before or after the adhesive layer 24 has been placed on a structure to be bonded, the frangible coating 37 breaks or ruptures 31 (see FIG. 9), thereby releasing the curing agent in the core 35. The release of the curing agent from the core 35 exposes the surrounding resin 28 to the curing agent, thereby activating and causing the latter to chemically cure 36 at room temperature.

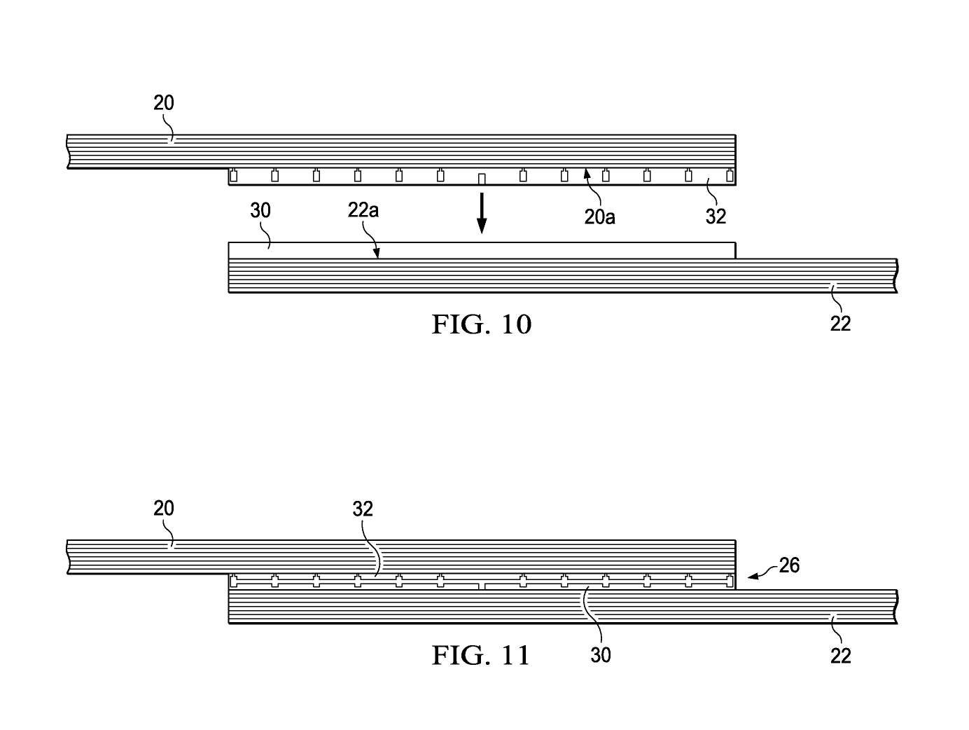

FIGS. 10 and 11 illustrate another embodiment in which the scrim 32 and a single, chemically activatable layer of resin 30 are respectively adhered or otherwise separately attached to the composite laminates 20, 22 that are to be bonded together. The resin 30 may comprise a film of uniform thickness and may be activated to cure at substantially room temperature. In this example, the scrim 32 is adhered to the bonding surface 20a of composite laminate 20 using any suitable means, such as a tackifier, while the layer of activatable resin 30 is likewise adhered to the bonding surface 22a of the composite laminate 22. The scrim 32 may be similar to that previously described, and possesses an outer coating (not shown in FIGS. 10 and 11) of an activator or a catalyst agent, such as the activator coating 34 previously described in connection with FIG. 3, or the catalyst agent 35 described previously in connection with FIGS. 4 and 5. In some variations, the scrim 32 and the adhesive resin layer 30 may be assembled together in preparation for a bonding operation, rather than being separately adhered to the bonding surfaces 20a, 20b. When the composite laminates 20, 22 are assembled together, as shown in FIG. 7, the scrim 32 is forced against and at least partially into the layer of raw adhesive 30. The resulting contact between the activator coating or catalyst agent on the scrim 32, and the activatable adhesive layer of resin 30 results in chemical activation and curing of the adhesive resin layer 30, thereby bonding the composite laminates 20, 22 together and forming a bondline 26 of substantially constant thickness.

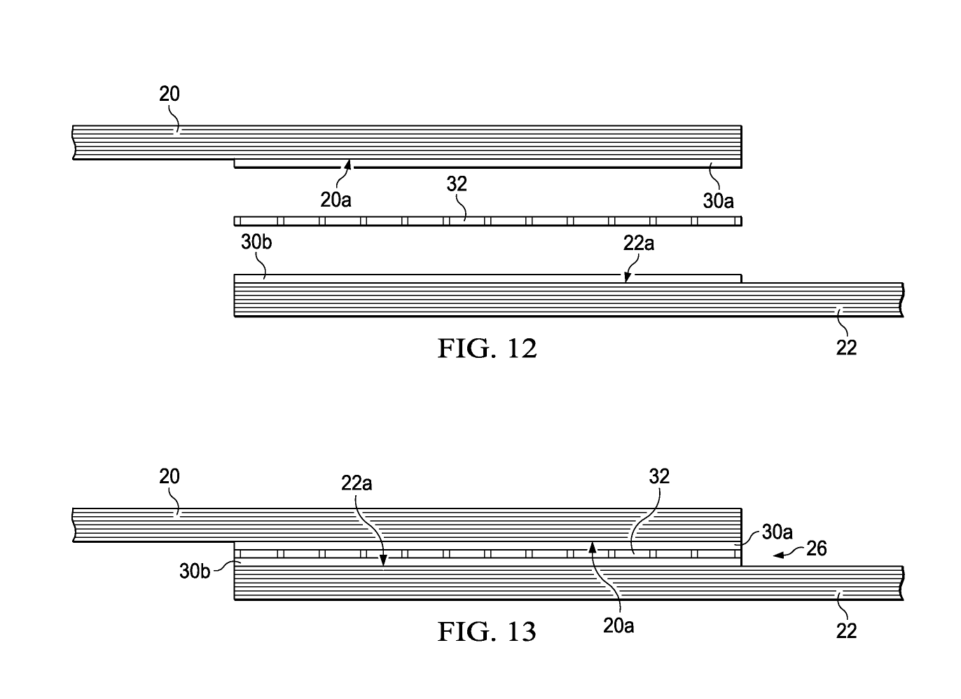

A further embodiment of a bond between two composite laminates 20, 22 that may be formed at room temperature is shown in FIGS. 12 and 13. In this example, two separate layers 30a, 30b of an adhesive resin, each of which may be a film of uniform thickness, are respectively adhered to bonding surfaces 20a, 22b of the composite laminates 20, 22. Each of the adhesive resin layers 30a, 30b is activatable to cure at room temperature. When ready to carry out a the bonding operation, a separate scrim 32 coated with an activator coating 34 or curing agent 35 of the type previously described (not shown in FIG. 8 and nine) is placed between the adhesive layers 30a, 30b as the two composite laminates 20 are being assembled together. As shown in FIG. 13, after assembly, the scrim 32 is sandwiched between each of the resin layers 30a, 30b. This physical contact between the outer activating coating 34 or curing agent 35 on the scrim 32 and the adhesive layers 30a, 30b causes the adhesive layers 30a, 30b to cure at room temperature, forming a strong bondline 26 have a substantially constant thickness.

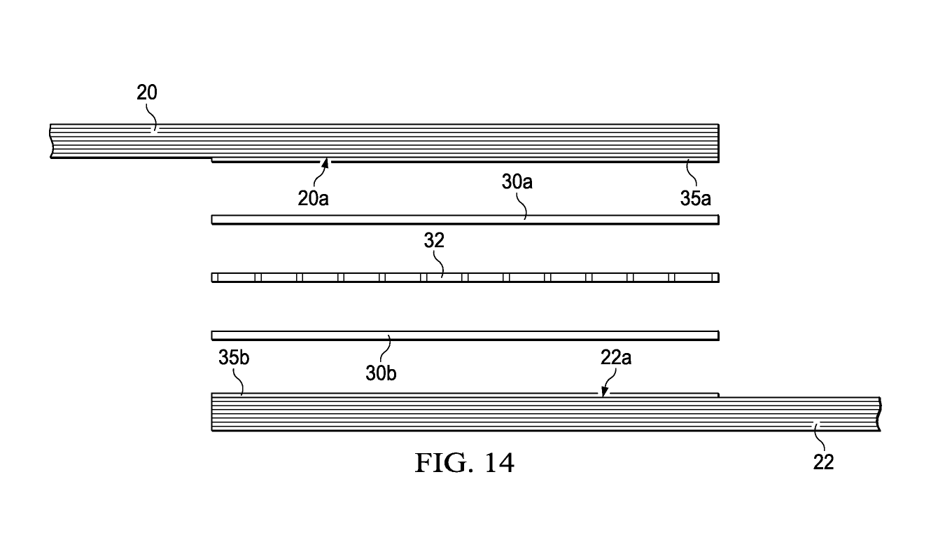

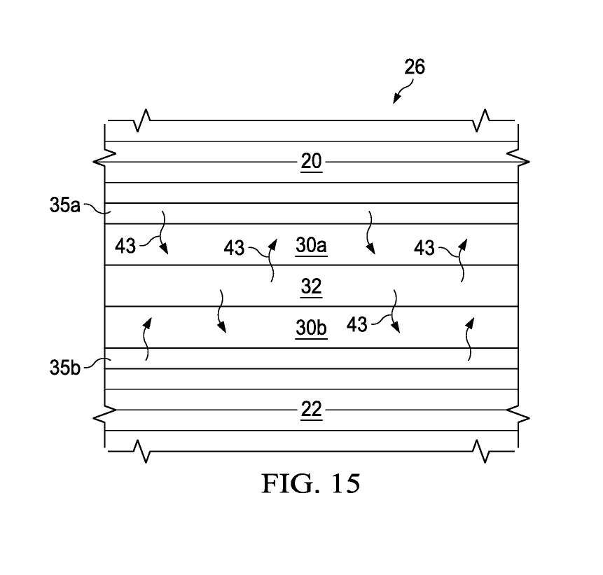

Attention is now directed to FIGS. 14 and 15 which illustrate still another embodiment of a bond that may be formed between two composite laminates 20, 22 at room temperature. In this embodiment, coatings 35a, 35b are respectively applied to the bonding surfaces 20a, 20b of the composite laminates 20, 22. The coatings 35a, 35b may be a paste or a film applied by any suitable technique and comprise an activator or curing agent which, when placed in contact with an activatable resin, cures the resin. A conventional scrim 32 is sandwiched between two layers 30a, 30b of adhesive resin that is activatable and curable at room temperature. The scrim 32 and the resin layers 30a, 30b may be preassembled if desired, prior to a bonding operation. In order to carry out a bonding operation, the assembly of the scrim 32 and the adhesive resin layers 30a, 30b are placed between the two laminates 20, 22. As the two laminates 20, 22 are assembled and pressed together, the two layers 30a, 30b respectively come into contact with the activator coatings 35a, 35b. This contact results in the activator coatings 35a, 35b chemically activating 43 (FIG. 15) the adhesive resin layers 30a, 30b to cure at room temperature. Although not shown in the Figures, optionally, the scrim 32 may also have a coating of an activator or curing agent to aid the cure process.

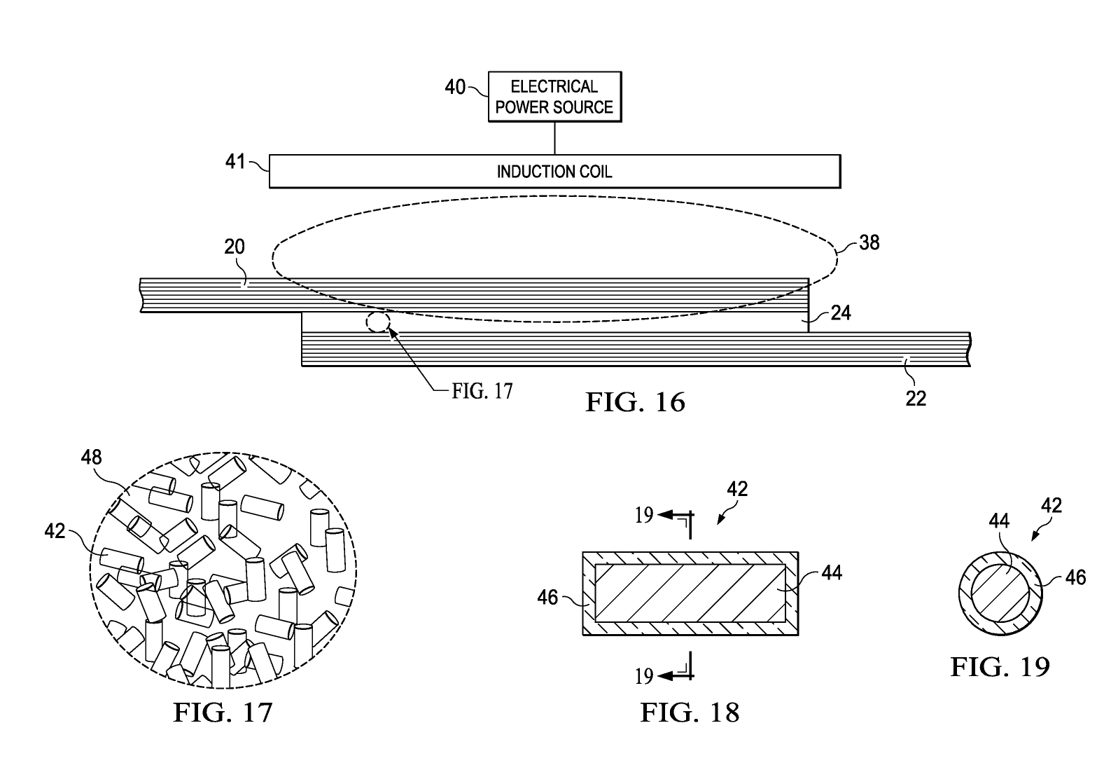

Attention is now directed to FIGS. 16-19 which illustrate another embodiment in which an adhesive resin film 24 is used to bond the two composite laminate parts 20, 22 together a room temperature using a thermal cure technique. In this embodiment, a scrim (not shown) may or may not be incorporated into the adhesive resin film 24. The adhesive resin film 24 comprises at least one layer of a resin 48 (FIG. 17) containing a thermally activated catalyst, as well as a dispersion of particles 42. Each of particles 42 comprises a small ferromagnetic metallic particle 44, such as nano-particulate iron, however other ferromagnetic materials may be used. Each of the ferromagnetic particles 44 is encapsulated by a suitable coating 46, which may comprise, without limitation, a hydrophobic fumed silica (i.e. glass) that also functions to thicken the resin. Although not shown in the Figures, the composite laminate parts 20, 22 may be covered with a vacuum bag that is employed to press the two parts 20, 22 together during the bonding process.

An electrical induction coil 41 (FIG. 16) is located in proximity to the adhesive resin film 24 and is coupled with an electrical power source 40, which may be an alternating current power source 40. The induction coil 41 generates an electromagnetic field 38 that is coupled with the encapsulated, ferromagnetic particles 44, which produces a current flow in the metal particles 44, causing Joule heating of the metal particles 44 due to their resistance to the current flow. The electromagnetic field 38 excites the ferromagnetic particles 44, causing them to produce friction which heats the surrounding resin 48 to the temperature needed to activate the catalyst in the resin 48. Once activated, the catalyst causes thermal curing of the resin adhesive. The strength and duration of the applied electromagnetic field 38 will depend upon the application, including the type of adhesive resin 48 employed, the percentage of loading, thicknesses of any intervening insulative layers (such as vacuum bagging) and the concentration of the dispersion of the ferromagnetic particles 44. In addition to effecting thermal curing of the resin, the ferromagnetic particles 44 may improve the electrical and mechanical properties of the bond.

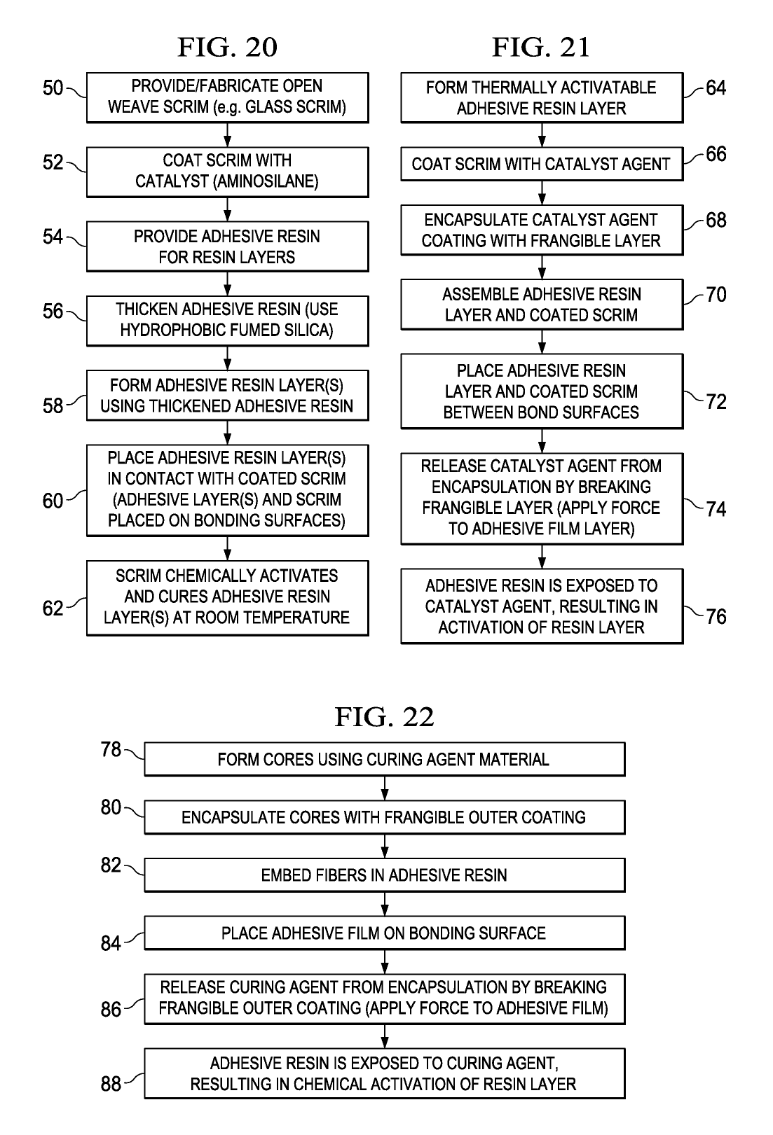

Attention is now directed to FIG. 20 which broadly illustrates the steps of a method of adhesive bonding at room temperatures. Beginning at step 50, an open weave scrim 32, which may comprise glass fibers 32a, is provided or fabricated. At 52, the scrim 32 is coated with a suitable activator coating or catalyst 34, which may comprise, without limitation, an aminosilane. At step 54, a suitable adhesive resin is provided, and at 56 the resin may be thickened using, for example and without limitation, a hydrophobic fumed silica. At 58, at least one adhesive resin later 28, 30 is formed using the thickened adhesive resin. At step 60, the adhesive resin layer 28, 30 is placed in contact with the coated scrim 32, and the adhesive resin layer and the coated scrim 32 are in turn placed between the bonding surfaces. At step 62, the coated scrim 32 chemically activates and cures the adhesive resin layer 28, 30 at room temperature.

FIG. 21 illustrates an alternate method of adhesive bonding at substantially room temperatures. At step 64, at least one activatable adhesive resin layer 28, 30 is formed by extruding, rolling, etc., a chemically thermally curable adhesive resin. At step 66, a scrim 32 is coated with a material 35 that acts as a catalyst agent suitable for activating the adhesive resin layer 28, 30. At 68, the coating 35 of the catalyst agent is encapsulated with a layer 37 of frangible material. At 70, the adhesive resin layer 28, 30 and the coated scrim are assembled together, and at 72 the assembly is placed between bonding surfaces 20a, 22a of two parts 20, 22. At step 74, the catalyst agent is released from encapsulation by breaking the frangible layer 37. Breaking the frangible layer 37 may be achieved by applying a force to the adhesive bonding film 24. At step 76, each of the adhesive resin layers 28, 30 is activated to cure as a result of its exposure to the catalyst agent.

FIG. 22 illustrates another method of adhesive bonding employing an adhesive film 24 comprising curing fibers 33 that chemically activate curing of adhesive resin 28 in which the curing fibers are embedded, at room temperature. At step 78, curing fibers 33 are formed having a core 35 of a material that acts as an activator or curing agent for curing resin 28 in which the fibers 33 are embedded. At 80, the core 35 is encapsulated by a coating 37 of a frangible material that prevents exposure of the surrounding resin 28 to the core 35 until the adhesive film 24 is ready for use. At 82, the curing fibers 33 are embedded within a chemically activatable adhesive resin 28 as by pressing or molding them into the resin. At step 84, the adhesive film 24 is placed on a bonding surface of a structure. At 86, a curing agent from which the core 35 is formed is released by applying a force to the adhesive film 24 which breaks the frangible outer coating 37, thereby exposing the surrounding resin 28 to the curing agent in the core 35.

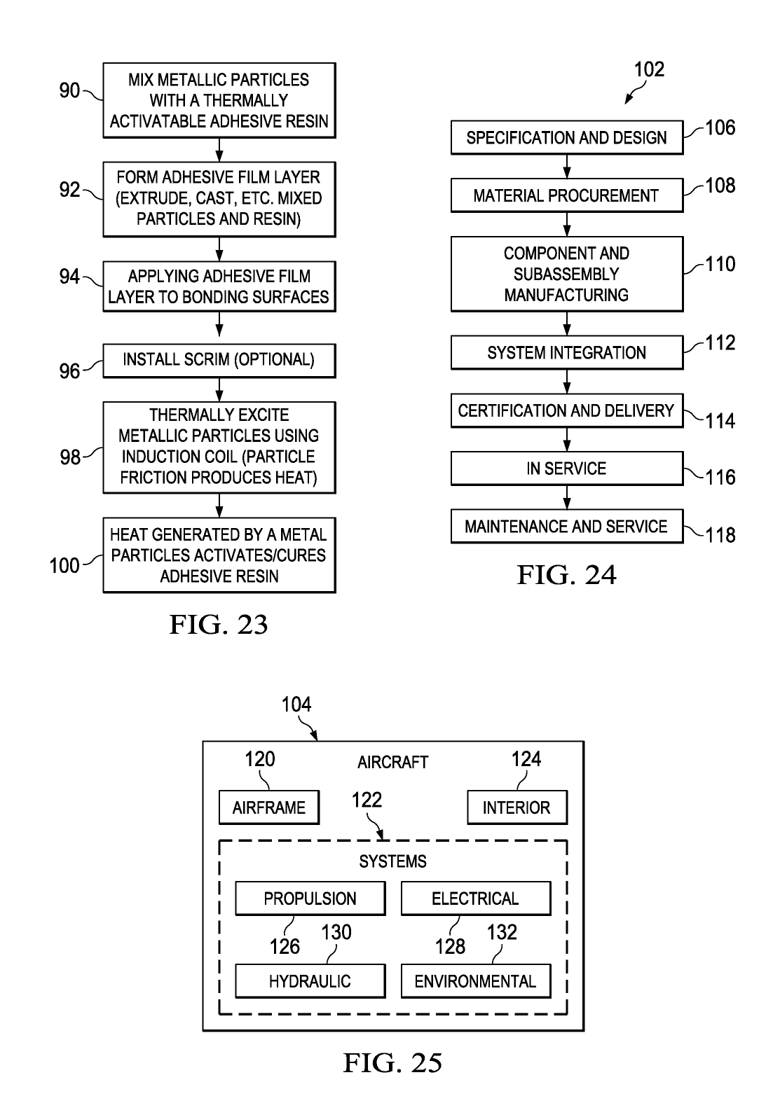

Still another embodiment of a method of adhesive bonding is shown in FIG. 23. Beginning at step 90, metallic particles 44 are mixed with a thermally activatable adhesive resin 48. At 92, an adhesive film layer 24 is formed of by extruding, casting, etc., the mixture of the metallic particles 44 and the resin 48. At step 94, the adhesive film layer 24 is applied to bonding surfaces 20a, 22a. Optionally, at step 96, a suitable scrim 32 may be installed against the adhesive film. At step 98, the metallic particles 44 are thermally excited using an induction coil 41 which produces friction between the metallic particles 44 that generates heat. At step 100 the heat generated by friction of the metallic particles 44 results in activation and curing of the adhesive resin 48.

Embodiments of the disclosure may find use in a variety of potential applications, particularly in the transportation industry, including for example, aerospace, marine, automotive applications and other applications where parts, particularly composite parts, require bonding. Thus, referring now to FIGS. 24 and 250, embodiments of the disclosure may be used in the context of an aircraft manufacturing and service method 102 as shown in FIG. 24 and an aircraft 104 as shown in FIG. 25. Aircraft applications of the disclosed embodiments may include, for example, without limitation, bonding components of the airframe 120 and the interior 124. During pre-production, exemplary method 102 may include specification and design 106 of the aircraft 104 and material procurement 108. During production, component and subassembly manufacturing 110 and system integration 112 of the aircraft 104 takes place. Thereafter, the aircraft 104 may go through certification and delivery 1148 in order to be placed in service 116. While in service by a customer, the aircraft 104 is scheduled for routine maintenance and service 118, which may also include modification, reconfiguration, refurbishment, and so on.

Each of the processes of method 102 may be performed or carried out by a system integrator, a third party, and/or an operator (e.g., a customer). For the purposes of this description, a system integrator may include without limitation any number of aircraft manufacturers and major-system subcontractors; a third party may include without limitation any number of vendors, subcontractors, and suppliers; and an operator may be an airline, leasing company, military entity, service organization, and so on.

As shown in FIG. 25, the aircraft 104 produced by exemplary method 102 may include an airframe 12004 with a plurality of systems 122 and an interior 124. Examples of high-level systems 122 include one or more of a propulsion system 126, an electrical system 128, a hydraulic system 130, and an environmental system 132. Any number of other systems may be included. Although an aerospace example is shown, the principles of the disclosure may be applied to other industries, such as the marine and automotive industries.

Systems and methods embodied herein may be employed during any one or more of the stages of the production and service method 102. For example, components or subassemblies corresponding to production process 110 may be fabricated or manufactured in a manner similar to components or subassemblies produced while the aircraft 88 is in service. Also, one or more apparatus embodiments, method embodiments, or a combination thereof may be utilized during the production stages 110 and 112, for example, by substantially expediting assembly of or reducing the cost of an aircraft 88. Similarly, one or more of apparatus embodiments, method embodiments, or a combination thereof may be utilized while the aircraft 104 is in service, for example and without limitation, to maintenance and service.

As used herein, the phrase “at least one of”, when used with a list of items, means different combinations of one or more of the listed items may be used and only one of each item in the list may be needed. For example, “at least one of item A, item B, and item C” may include, without limitation, item A, item A and item B, or item B. This example also may include item A, item B, and item C or item B and item C. The item may be a particular object, thing, or a category. In other words, at least one of means any combination items and number of items may be used from the list but not all of the items in the list are required.

The description of the different illustrative embodiments has been presented for purposes of illustration and description, and is not intended to be exhaustive or limited to the embodiments in the form disclosed. Many modifications and variations will be apparent to those of ordinary skill in the art. Further, different illustrative embodiments may provide different advantages as compared to other illustrative embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. An adhesive bonding film, comprising:
at least a first layer of activatable resin; and
a coating adapted to be placed against the layer of resin for activating curing of the layer of resin.

2. The adhesive bonding film of claim 1, further comprising:
a scrim, and
wherein the coating is on the scrim.

3. The adhesive bonding film of claim 2, further comprising:
a second layer of activatable resin,
wherein the scrim is sandwiched between the first and second layers of activatable resin.

4. The adhesive bonding film of claim 2, wherein the scrim includes a coating of a material acting as a catalyst to activate curing of the layer of resin.

5. The adhesive bonding film of claim 4, wherein the material acting as a catalyst is selected from the group consisting of amines and micro-capsulated activators.

6. The adhesive bonding film of claim 4, wherein the coating comprises a silane.

7. The adhesive bonding film of claim 4, wherein the coating of a material acting as a catalyst is encapsulated by a frangible layer preventing exposure of the material acting as the catalyst to the activatable resin.

8. The adhesive bonding film of claim 2, wherein the scrim includes at least one of a peroxide base, titanium base, or platinum base.

9. The adhesive bonding film of claim 2, wherein the scrim is an open weave of glass fibers.

10. The adhesive bonding film of claim 2, wherein the activatable resin includes a hydrophobic fumed silica for thickening the activatable resin.

11. The adhesive bonding film of claim 2, wherein the activatable resin is activated by the scrim to cure at substantially room temperatures.

12. An adhesive bonding film, comprising:
at least one layer of a chemically curable resin; and
an encapsulated curing agent that is released from encapsulation to cure the chemically curable resin in response to application thereto of a force.

13. The adhesive bonding film of claim 12, further comprising:
a scrim, and
wherein the curing agent is a coating on the scrim.

14. The adhesive bonding film of claim 12, wherein the encapsulated curing agent includes substantially continuous fibers, each of the fibers including a curing agent core and a frangible outer coating normally forming a barrier between the curing agent core and the chemically curable resin, but breakable to expose the curing agent core to the chemically curable resin.

15. The adhesive bonding film of claim 14, wherein the continuous fibers are arranged in layers distributed through a thickness of the layer of the chemically curable resin.

16. The adhesive bonding film of claim 12, wherein the encapsulated curing agent includes:
a plurality of generally randomly oriented fibers, each of the fibers including a curing agent core, and a frangible outer coating surrounding the curing agent core, the frangible outer coating normally forming a barrier between the curing agent core and the chemically curable resin, but breakable upon the application thereto of a force to release and expose the curing agent core to the chemically curable resin.

17. A method of making an adhesive bonding film, comprising:
forming at least one layer of an activatable adhesive;
coating a scrim with a catalyst; and
chemically activating the adhesive by placing the coated scrim in contact with the at least one layer of an activatable adhesive.

18. The method of claim 17, wherein the chemical activation of the adhesive resulting from placing the coated scrim in contact with the at least one layer of an activatable is performed at substantially room temperature.

19. The method of claim 17, wherein coating the scrim includes applying an aminosilane to the scrim.

20. The method of claim 17, further comprising:
thickening the activatable adhesive with a hydrophobic fumed silica.

21. A method of forming an adhesive bond at room temperature, comprising:
forming a layer of resin;
forming a separate scrim cloth; and,
using the scrim cloth to chemically activate curing of the resin layer.

22. The method of claim 21 wherein using the scrim cloth to chemically activate curing is performed using a catalyst selected from the group consisting of:
a peroxide base,
a titanium (TI) base, and
a platinum base.
